(19) United States
(12) Patent Application Publication
(10) Pub. No.: US 2008/0240827 A1
(43) Pub. Date: Oct. 2, 2008

(54) Printing apparatus

(75) Inventor: Yoji Yamazaki, Tokyo (JP)

Correspondence Address: RABIN & Berdo, PC, 1101 14TH STREET, NW, SUITE 500, WASHINGTON, DC, 20005, US

(73) Assignee: OKI DATA CORPORATION, Tokyo (JP)

(21) Appl. No.: 12/078,007

(22) Filed: Mar. 26, 2008

(30) Foreign Application Priority Data
Mar. 27, 2007 (JP) 2007-081958

(51) Int. Cl. B41J 5/30

(52) U.S. Cl. 400/73

(57) ABSTRACT

A printing apparatus is provided that can display information necessary for recovery during operation of the printing apparatus to a user at low cost. The printing apparatus of the present invention performs printing upon receiving print information generated by a print information generation apparatus, and the printing apparatus can communicate with an external processing apparatus such as a portable telephone held by the user. The printing apparatus further has a short-range data communication unit performing wireless personal area network communication such as infrared communication, and transmits printing apparatus information showing the status of the printing apparatus such as error messages about the printing apparatus to the external processing apparatus via the short-range data communication unit.

### BACKGROUND OF THE INVENTION

1. Area of the Invention

The present invention relates to a printing apparatus capable of obtaining information about the status of the printing apparatus and communicating the obtained information about the printing apparatus to an external processing apparatus.

2. Description of Related Art

Printing apparatuses having an electrophotographic recording unit such as printers, facsimile machines, photo copiers, and the like may cause errors such as paper jamming of a fed recording medium, running out of the recording medium, and the like. In the event of such errors, recovery operation is performed with a paper conveyance mechanism being halted, and accordingly, printing operation is suspended during the recovery operation.

During the recovery operation, a user usually performs an operation such as checking a paper conveyance path and pulling out a tray to see the inside the tray where the printing apparatus has the tray and the like. The printing apparatus needs to have a display unit to show the status of the printing apparatus and especially a portion at which a problem has occurred so that the user can efficiently proceed with the recovery operation. The user often proceeds with the recovery operation relying on the information about the printing apparatus displayed on the display unit.

Technology such as Japanese Patent Application Publication No. 10-333379 is known through which a printing apparatus selectively activates a driving mechanism of the conveyance path according to signals supplied by detection units arranged at various portions in the printing apparatus to allow the user to improve the efficiency in recovering the printing apparatus in the event of such errors.

The printing apparatus as described above needs to have the display unit showing the status of the printing apparatus to the user to allow the user to use the printing apparatus, and where the display unit specifically shows a portion needing treatment by the user, the printing apparatus requires the display unit and a liquid crystal display panel capable of handling such various situations, thus resulting in overall increase in the cost of the printing apparatus.

This invention is made to solve the above technical problem, and it is the object of the present invention to provide the printing apparatus capable of showing detailed information about the printing apparatus to the user at low cost.

To solve the above technical problem, the printing apparatus of the present invention performs printing upon receiving print information generated by a print information generation apparatus, and the printing apparatus has a short-range data communication unit communicating with an external processing apparatus, wherein the printing apparatus transmits printing apparatus information showing the status of the printing apparatus to the external processing apparatus via the short-range data communication unit.

The short-range data communication unit performing short-range data communication can perform wireless communication as an example of the short range data communication, and for example, the wireless communication may be performed by one or more methods selected from the group of wireless infrared communication, ultra-wideband communication, and wireless spread spectrum communication.

For example, a portable telephone widely available to consumers may be used as the external processing apparatus. A display screen of the portable telephone may be used as the display unit for the printing apparatus to show the status of the printing apparatus.

In one example of the printing apparatus of the present invention, the short-range data communication may be controlled to start and stop according to an error detection of the printing apparatus. The printing apparatus or the external processing apparatus may have an operation unit allowing a user to enter an input, and wherein the short-range data communication is controlled to start and stop according to the input entered by the user to the operation unit.

The printing apparatus of the present invention can provide the printing apparatus information to the external processing apparatus such as the portable telephone from the printing apparatus itself, and thus, the user can obtain detailed information about the printing apparatus without a fine display unit showing the printing apparatus information arranged on the body of the printing apparatus.

### DETAILED DESCRIPTION OF THE DRAWINGS

This invention may take physical form in certain parts and arrangements of parts, a preferred embodiment and method of which will be described in detail in this specification and illustrated in the accompanying drawings which form a part hereof, and wherein:

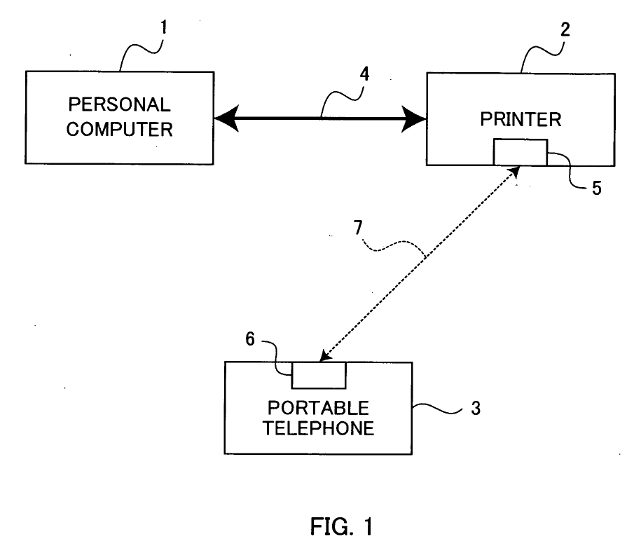

FIG. 1 is a schematic diagram of a printing system according to the first embodiment of the present invention;

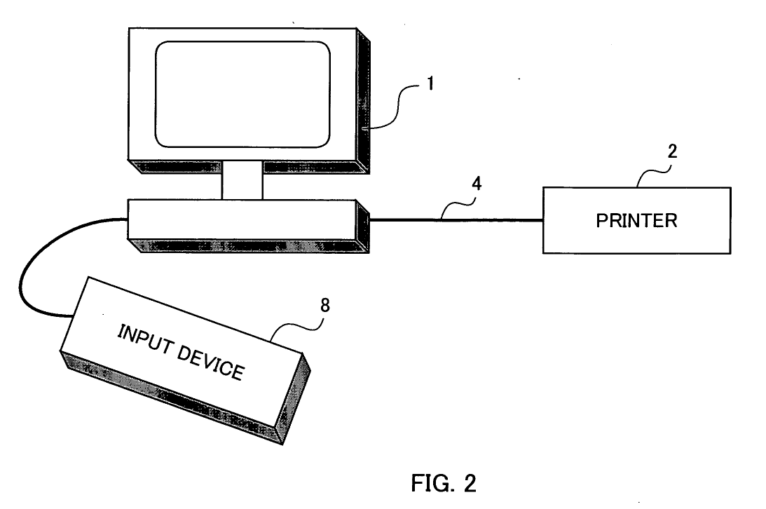

FIG. 2 is a connection diagram between the personal computer 1 and peripheral devices according to the first embodiment;

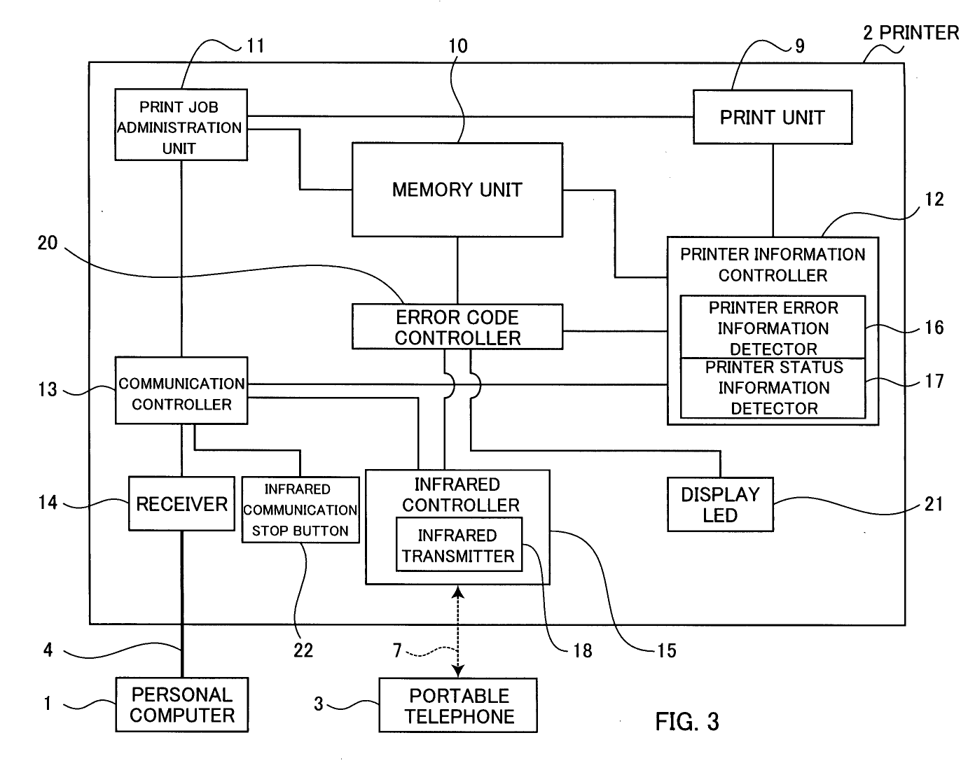

FIG. 3 is a control block diagram of the printing apparatus (printer) according to the first embodiment;

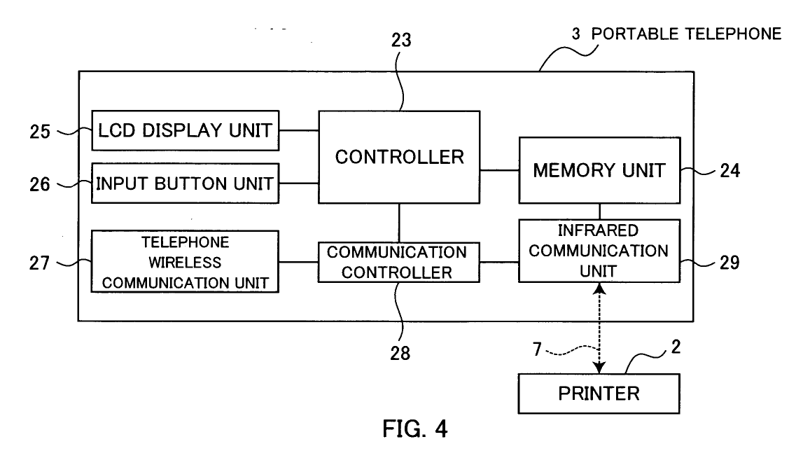

FIG. 4 is a control block diagram of the portable telephone according to the first embodiment of the present invention;

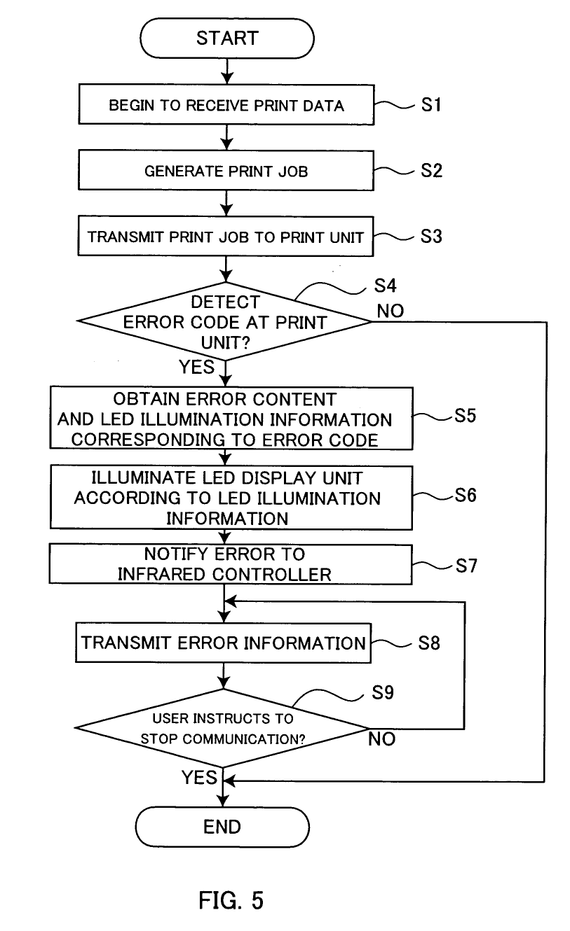

FIG. 5 is a flowchart describing operation of the printing apparatus according to the first embodiment of the present invention;

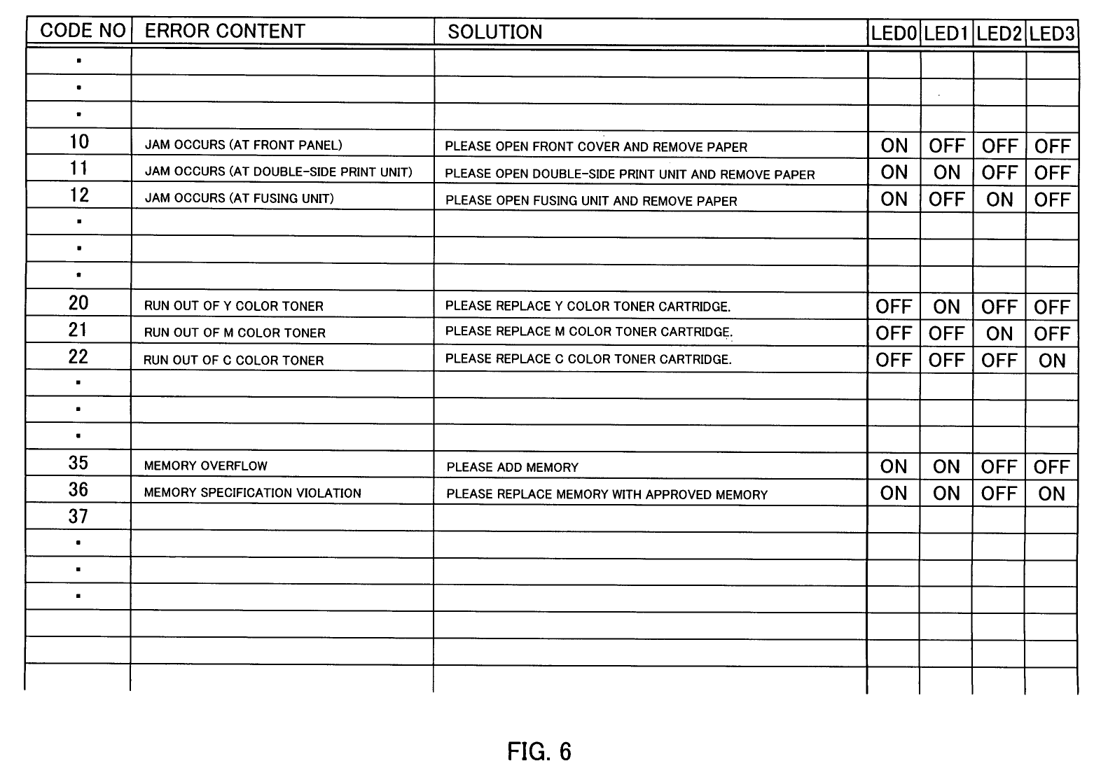

FIG. 6 is a diagram showing the an error code list according to the first embodiment of the present invention;

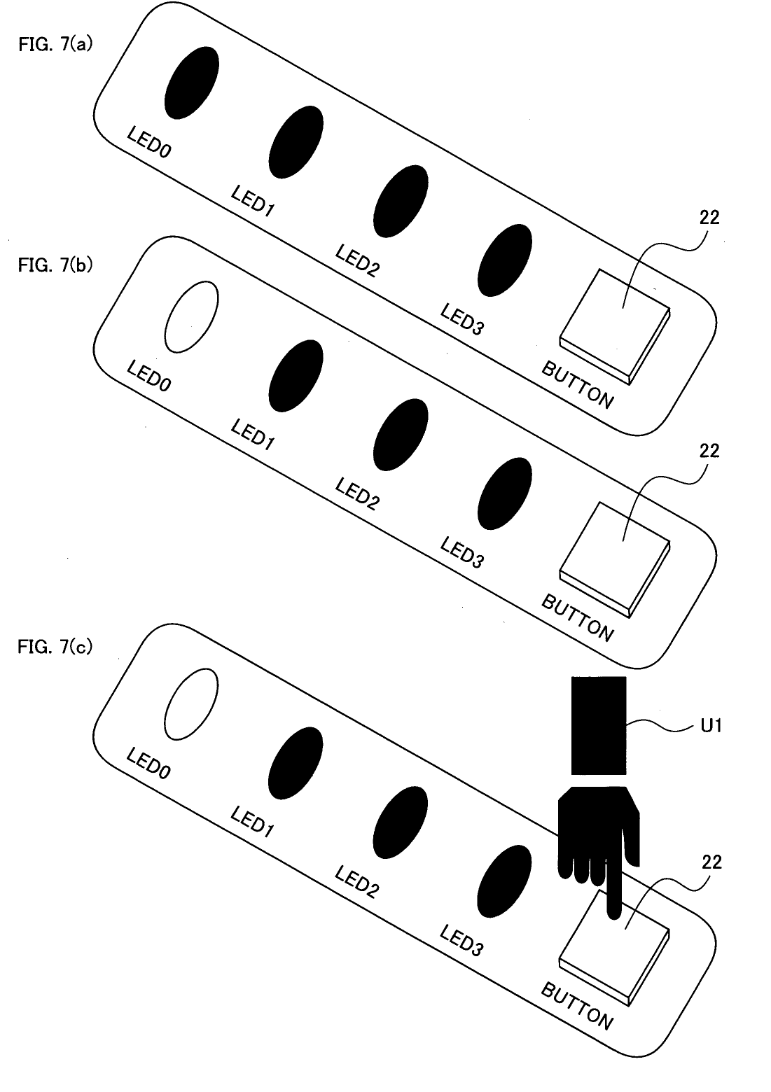

FIG. 7 is a diagram showing the status of the display unit of the printing apparatus according to the first embodiment of the present invention, FIG. 7 (a) shows the status where LED0 to LED3 are all turned off, FIG. 7 (b) shows the status where LED0 illuminates but LED1 to LED3 are turned off, and FIG. 7 (c) shows the status where LED0 illuminates but LED1 to LED3 are turned off while a user pushes an infrared communication stop button;

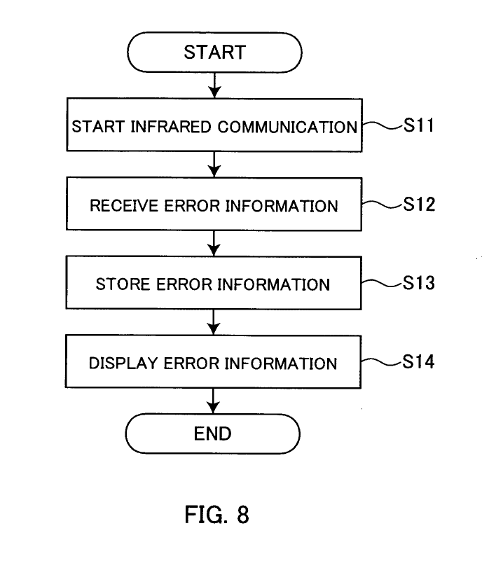

FIG. 8 is a flowchart describing operation of the portable telephone according to the first embodiment of the present invention;

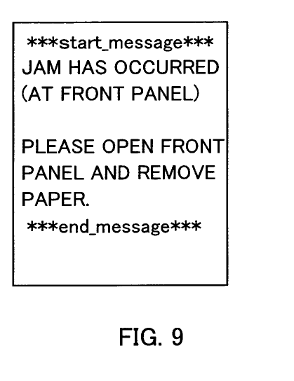

FIG. 9 is an example of an error message format according to the first embodiment of the present invention;

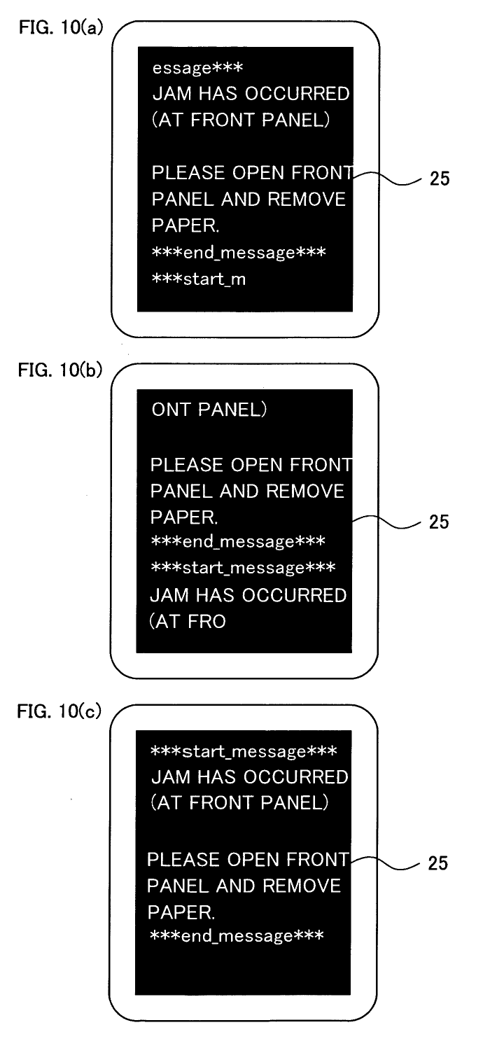

FIG. 10 is a schematic diagram of a liquid crystal display of the portable telephone showing a display example of error messages according to the first embodiment of the present invention, FIG. 10 (a) and FIG. 10 (b) are examples where the error messages displayed from the middle of the error messages, and FIG. 10 (c) is an example where the message is displayed from start to end;

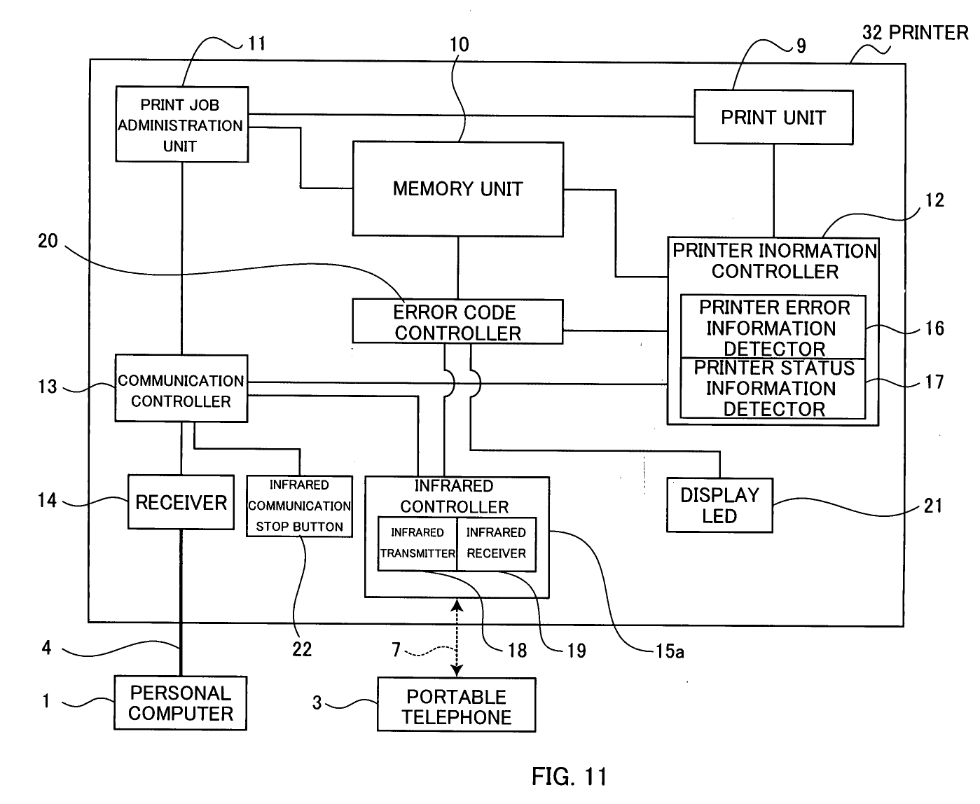

FIG. 11 is a block diagram of the printing apparatus (printer) according to the second embodiment of the present invention;

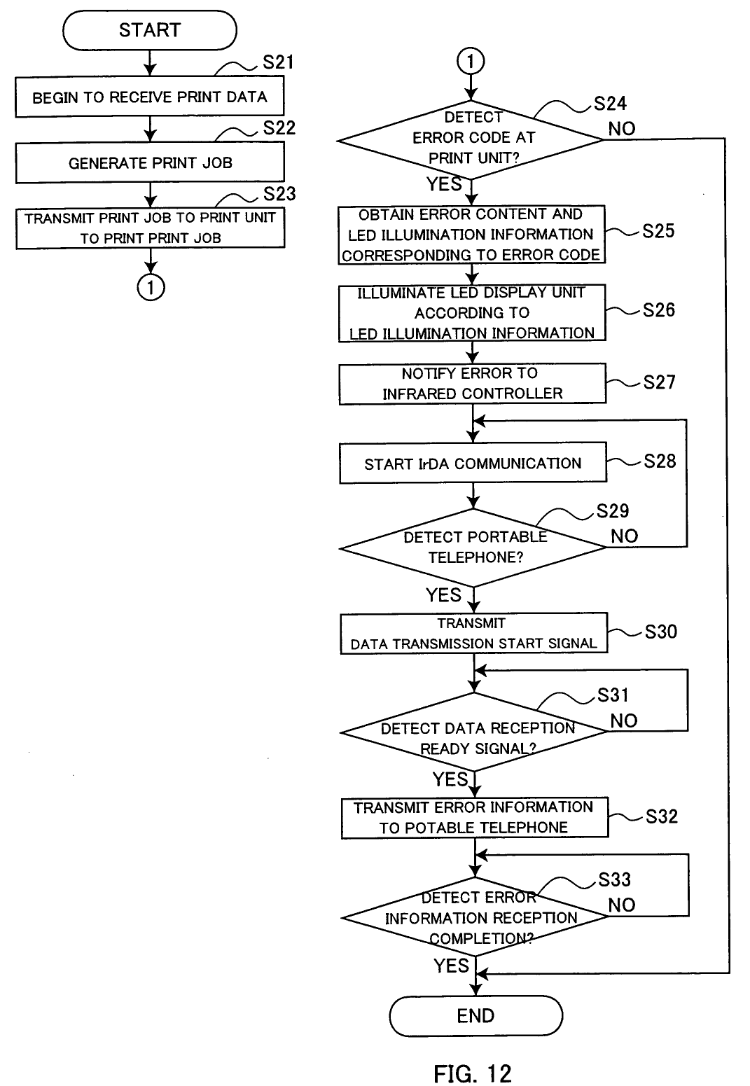

FIG. 12 is a flowchart describing operation of the printing apparatus according to the second embodiment of the present invention;

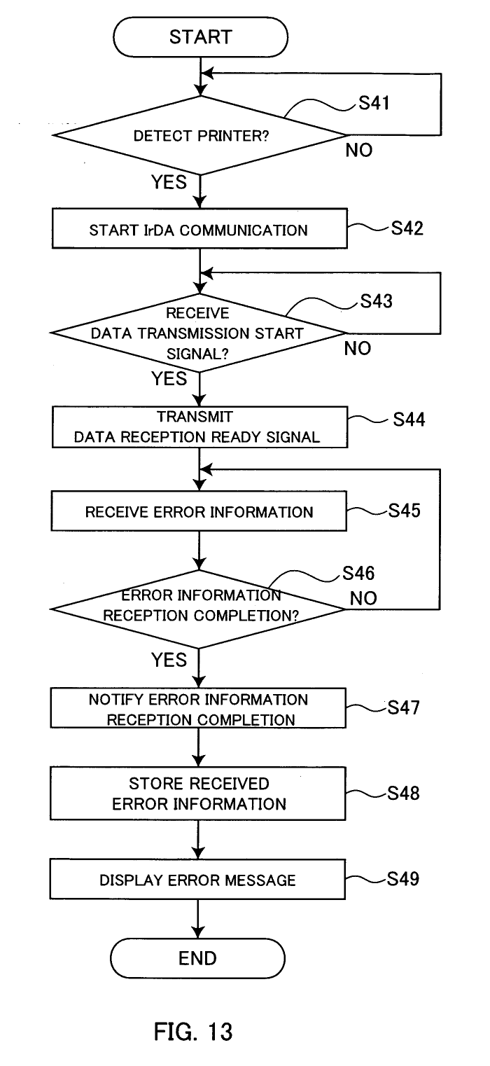

FIG. 13 is a flowchart describing operation of the portable telephone according to the second embodiment of the present invention;

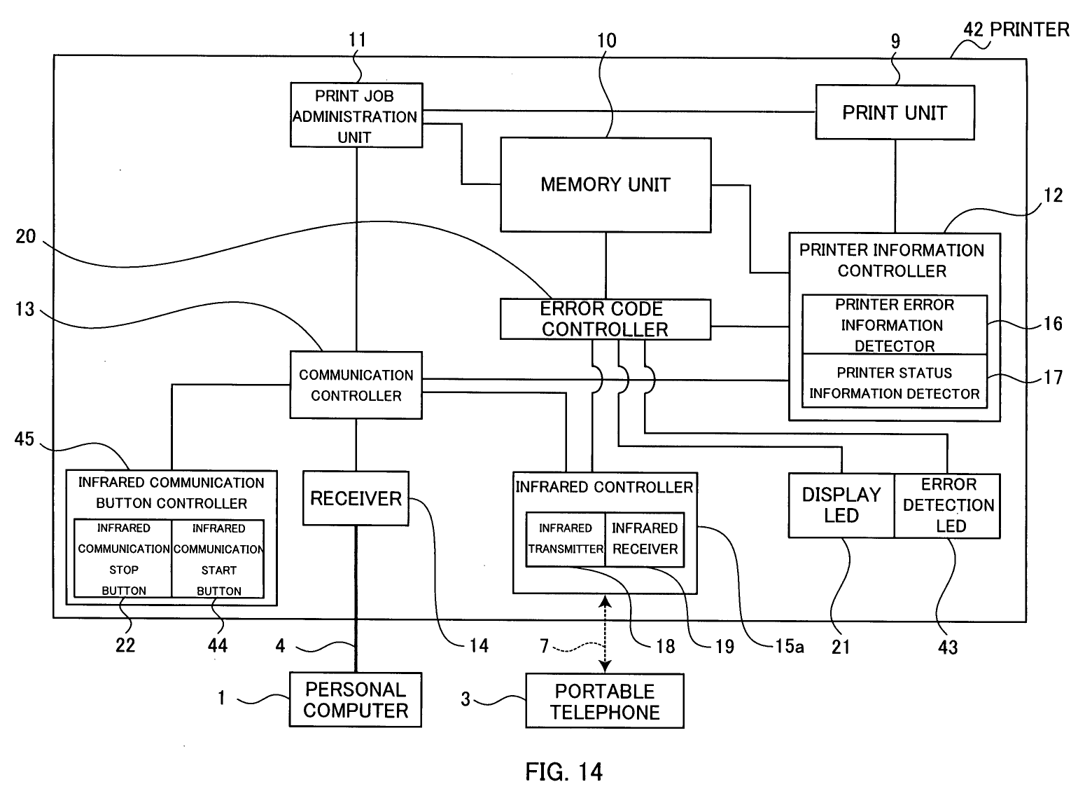

FIG. 14 is a block diagram of the printing apparatus (printer) according to the third embodiment of the present invention;

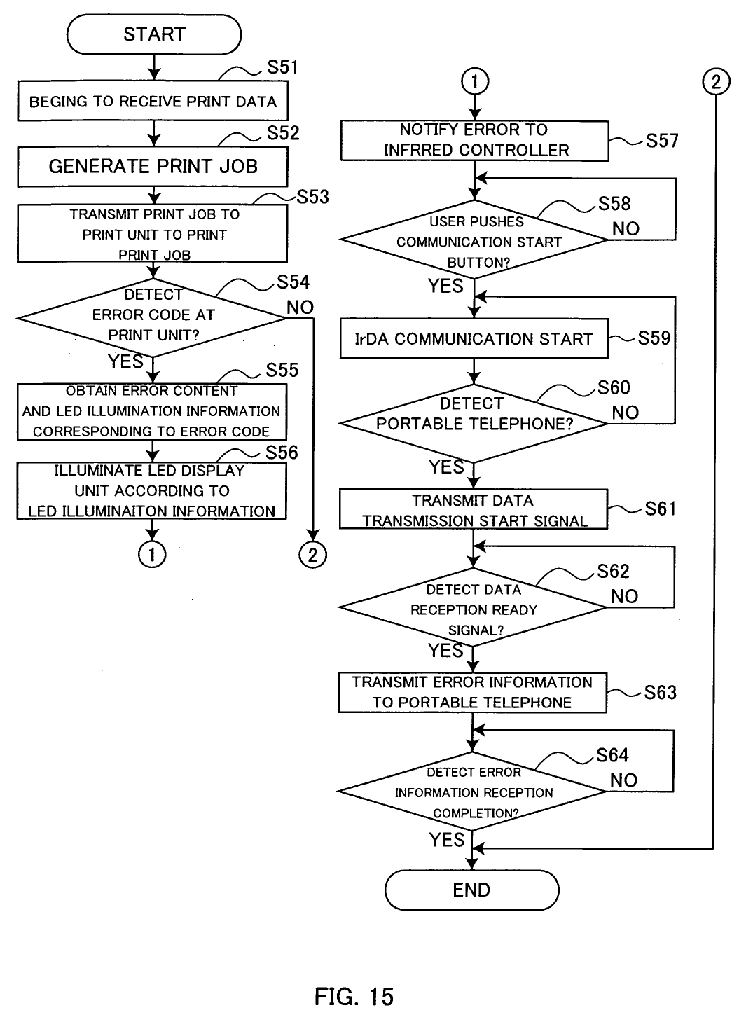

FIG. 15 is a flowchart describing operation of the printing apparatus according to the third embodiment of the present invention;

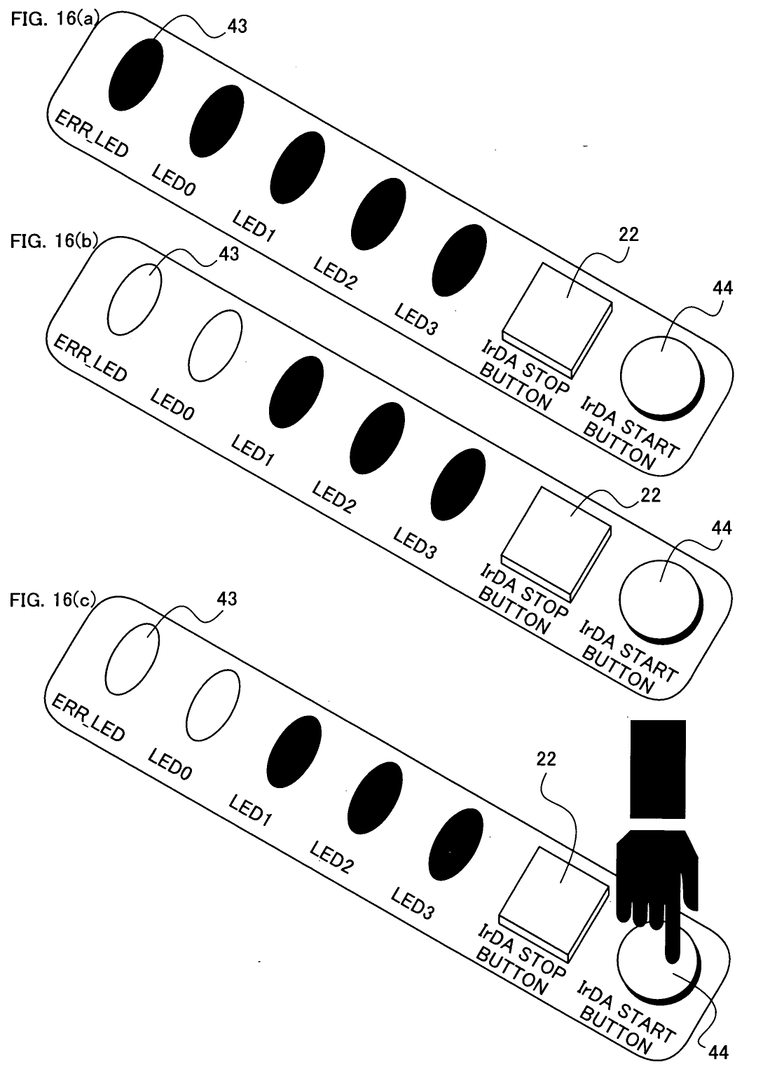

FIG. 16 is a diagram showing the status of the display unit according to the third embodiment of the present invention, FIG. 16 (a) shows the status where ERR_LED and LED0 to LED3 are all turned off, FIG. 16 (b) shows the status where ERR_LED and LED0 illuminate but LED1 to LED3 are turned off, and FIG. 16 (c) shows the status where ERR_LED and LED0 illuminate but LED1 to LED3 are turned off while the user pushes an infrared communication start button;

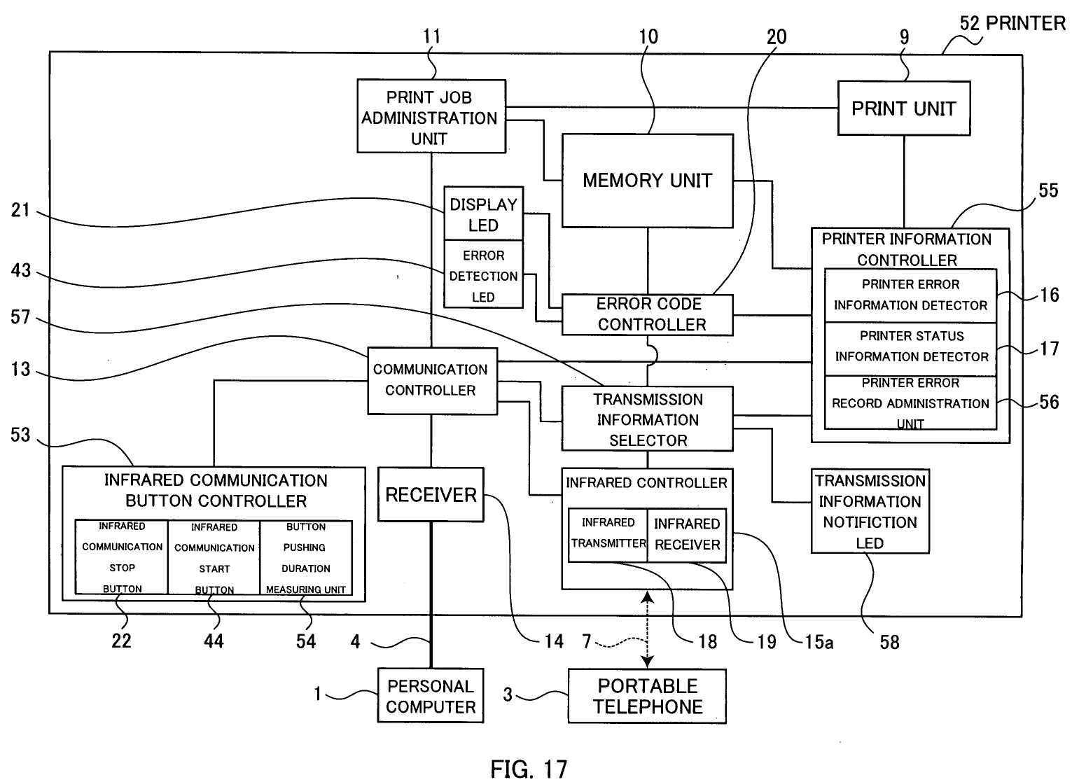

FIG. 17 is the block diagram of the printing apparatus (printer) according to the fourth embodiment of the present invention;

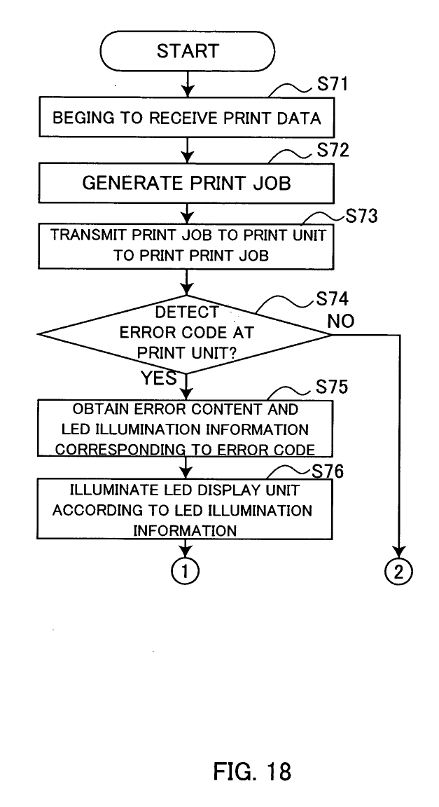

FIG. 18 is a flowchart describing operation of the printing apparatus according to the fourth embodiment of the present invention;

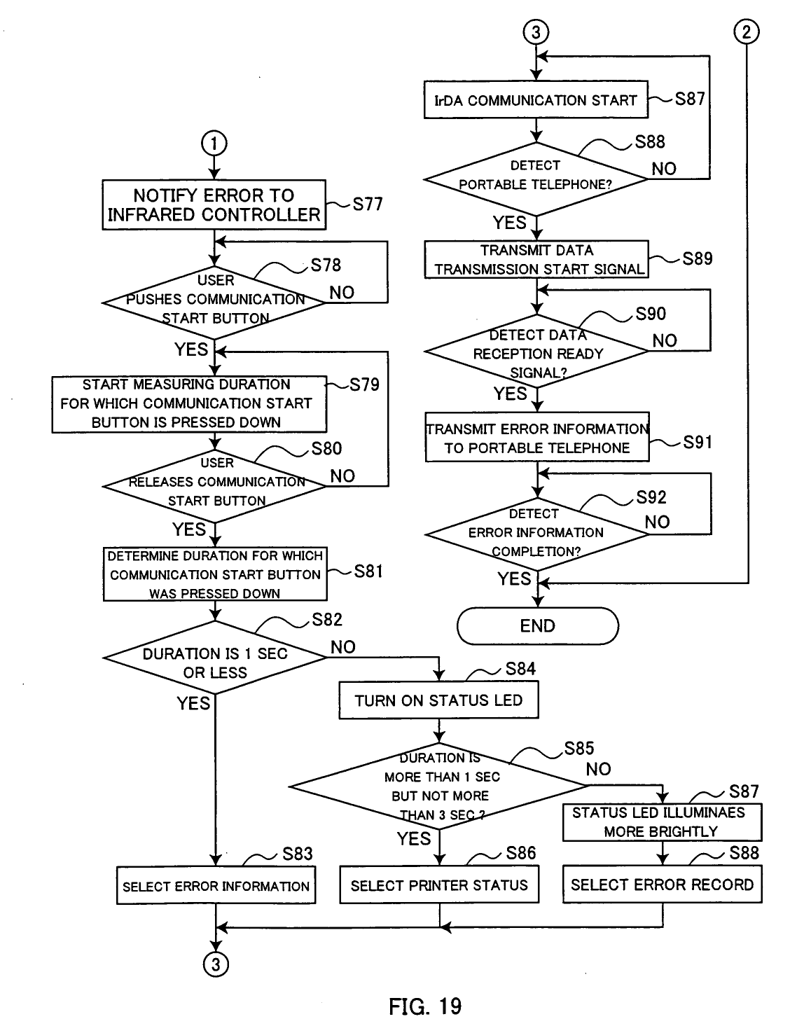

FIG. 19 is a flowchart describing operation of the printing apparatus according to the fourth embodiment of the present invention;

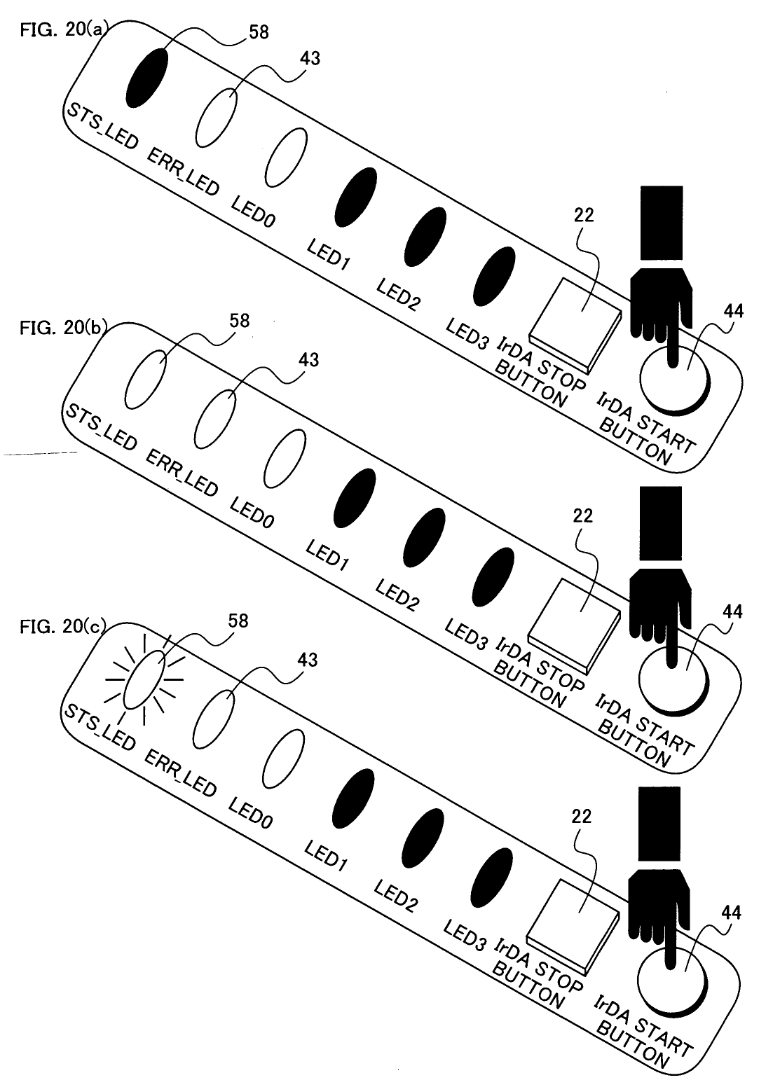

FIG. 20 is a diagram showing the status of the display unit of the printing apparatus according to the fourth embodiment of the present invention, FIG. 20 (a) shows the status where ERR_LED and LED0 illuminate but STS_LED and LED1 to LED3 are turned off while the user pushes the infrared communication start button for 1 second or less, FIG. 20 (b) shows the status where STS_LED, ERR_LED, and LED0 illuminate but LED1 to LED3 are turned off while the user pushes the infrared communication start button for more than one second but not more than 3 seconds, and FIG. 20 (c) shows the status where STD_LED illuminates more brightly and ERR_LED and LED0 illuminate but LED1 to LED3 are turned off while the user pushes the infrared communication start button for more than three seconds; and

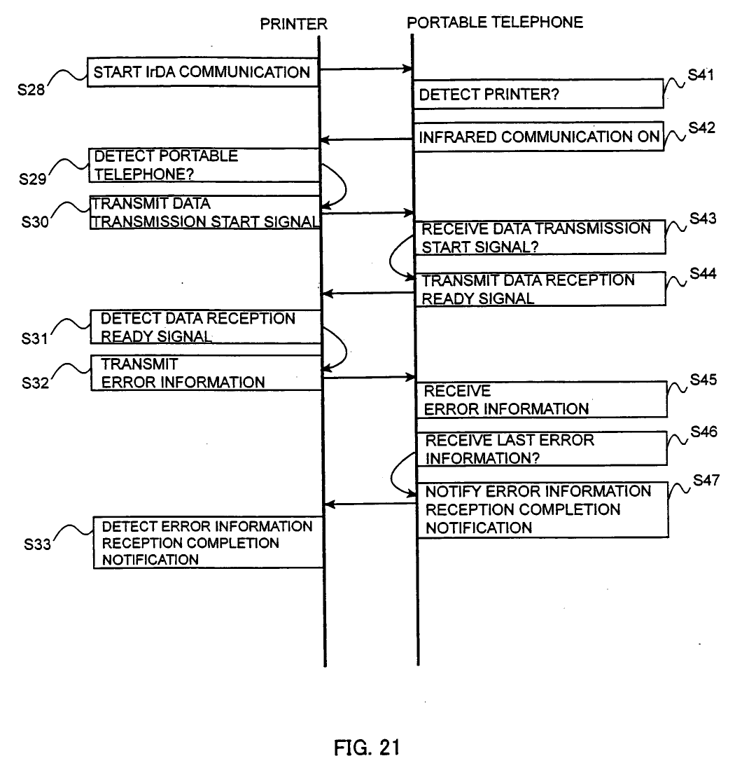

FIG. 21 is a timing diagram showing communication between the printing apparatus (printer) and the portable telephone.

### PREFERRED EMBODIMENTS

### First Embodiment

The preferred embodiments of the present invention is hereinafter described with reference to the figures. FIG. 1 is a schematic diagram of a printing system including a printing apparatus (printer) according to the first embodiment of the present invention. The first embodiment describes an example in which the printing system for image formation is divided into a personal computer 1 serving as a print information generation apparatus and a printer 2 serving as a printing apparatus, and a portable telephone 3 is employed as an external processing apparatus communicating via wireless personal area network.

As shown in FIG. 1, the personal computer 1 and the printer 2 are connected via a local area network 4 such as Ethernet. The printer 2 and the portable telephone 3 have short-range wireless data communication units 5 and 6, respectively, to perform wireless data communication in short range. The printer 2 and the portable telephone 3 can perform data communication with each other through a communication path 7 via IrDA (Infrared Data Association) communication, namely, infrared communication according IrDA standards. It should be noted that the multiple portable telephones 3 may exist, but in the example of FIG. 1, only one portable telephone is shown as a representative.

FIG. 2 is a connection diagram between the personal computer 1 and peripheral devices according to the first embodiment. As shown in FIG. 2, an input device 8 such as mouse and keyboard is connected to the personal computer 1, and a local area network 4 is established to allow the personal computer 1 to perform data communication with the printer 2 via a LAN cable or wireless LAN equipments. Multiple personal computers 1 and multiple printers 2 may be connected to the same network. The personal computer 1 generates an image data according to input information based on operations performed a user with the input device 8, and transmits the generated image data to the printer 2 via the local area network 4.

FIG. 3 is a control block diagram of the printer 2 according to the first embodiment. The printer 2 is, for example, an electrophotographic printer or an inkjet printer. As shown in FIG. 3, the printer 2 has a memory unit 10, a receiver 14 performing data communication with the personal computer 1 via the local area network 4, an infrared controller 15 performing data communication with the portable telephone 3 via a wireless communication path 7 according to IrDA communication method, namely, infrared communication according to IrDA standards, and a print unit 9 performing print jobs and having a mechanism such as a printer head and an exposure drum.

The printer 2 further has: a print job administration unit 11 managing the print jobs such as storing the received print job in the memory unit 10, reading the print job, transmitting data of the print job to the print unit 9, and the like; a printer information controller 12 extracting printer information from the print unit 9 during printing; and a communication controller 13 controlling the data communication with the personal computer 1 via the receiver 14 and the data communication with the portable telephone 3 via the infrared controller 15.

The memory unit 10 in the printer 2 is a hard disk drive of the printer 2. The memory unit 10 is also used to memorize the print jobs received by the receiver 14 through the data communication with the personal computer 1. A printer error status of the printer information controller 12 is expressed as an error code, and the memory unit 10 also stores an error code list listing the error codes.

Printing apparatus information is mainly sent from the print unit, and can be categorized into: printer error information showing information about printing inability such as paper jamming (JAM) and running out of toner; and printer status information showing the status of the printer such as the condition of consumables and the temperature of a thermistor inside the print unit. The printer information controller 12 is a unit managing the printing apparatus information, and has a printer error information detector 16 inside thereof detecting the printer error information and sends the error code to an error code controller 20. The printer information controller 12 also has a printer status information detector 17 inside thereof detecting the printer status information.

Upon receiving the error code from the printer information controller 12, the error code controller 20 looks up the error code in the error code list in a table format stored in the memory unit 10. The infrared controller 15 has an infrared transmitter 18 transmitting data based on a signal from the error code controller 20 via infrared. When the error code controller 20 obtains the printer error information, the error code controller 20 obtains LED illumination information corresponding to the error code from the error code list. A display LED 21 has a prescribed LED driver circuit, and illuminates each LED according to the LED illumination information corresponding to the error code. The user pushes an infrared communication stop button 22 to send to the communication controller 13 a signal for stopping the infrared communication, and the communication controller 13 controls the infrared controller 15 to stop operation of the infrared controller 15.

FIG. 4 is a control block diagram of the portable telephone 3 serving as the external processing apparatus according to the first embodiment of the present invention. As shown in FIG. 4, the portable telephone 3 is not only capable of voice telephone communication but also capable of data communication to connect to the Internet, and for example, the portable telephone 3 is a portable apparatus capable of sending and receiving e-mails. The portable telephone 3 has a memory unit 24 memorizing data, an LCD display unit 25 such as a liquid crystal display, an input button unit 26 such as operation buttons, an infrared communication unit 29 performing data communication with the printer 2 via infrared communication according IrDA standards, a telephone wireless communication unit 27 performing wireless communication for voice telephone, a communication controller 28 controlling data communication with the printer 2 via the infrared communication unit 29 and communication via the telephone wireless communication unit 27, and a controller 23 controlling displaying on the LCD display unit 25, controlling various units according to operation performed with the input button unit 26, and controlling the communication controller 28.

Operation of the printing apparatus according to the first embodiment is hereinafter described with reference to FIGS. 5 to 8. FIG. 5 is a flowchart showing steps in which the personal computer 1 transmits the data of the print job to the printer 2, the printer 2 prints an image according to the print job, the print unit 9 detects the printer error information during printing, and the printer 2 finishes processing after the detection and judgment.

The user uses the personal computer 1 to transmit an image data to the printer 2. The receiver 14 in the printer 2 begins to receive the image data via the local area network 4 (S1). The print job administration unit 11 in the printer 2 receives the received image data via the communication controller 13, and generates the print job corresponding to the received image data (S2). The print job administration unit 11 transmits the generated print job to the print unit 9, and the print unit 9 prints the image corresponding to the print job (S3).

Where an error occurs in the print unit 9 during printing, a controller, not shown, in the print unit notifies the printer information controller 12 of the printer error information. The error code is a number assigned to a corresponding error content. In the event of the printer error information, the printer error information detector 16 obtains the prescribed error code (S4). Where the printer error information detector 16 does not detect the printer error information, this processing terminates normally. Where the printer error information detector 16 detects the error, step S5 is performed. Suppose that the error code “10” is obtained in this first embodiment.

For example, FIG. 6 is the error code list showing the relationship between the printer error code, the printer error information including the printer error content and a solution, and LED illumination information. The error code list is always stored in a prescribed memory area in the memory unit 10. The printer error information detector 16 notifies the printer error code to the error code controller 20. Upon receiving the error code, the error code controller 22 obtains the printer error information and the LED illumination information corresponding to the error code from the memory unit 10 (S5). In the first embodiment, the error code controller 22 looks up the error code “10” in the error code list of FIG. 6 to find out that the printer error information comprised of the printer error content and the solution is “JAM has occurred (at front panel). Please open front panel and remove paper.”, and that the LED illumination information is “LED0:ON, LED1:OFF, LED2:OFF, LED3:OFF”. The obtained LED illumination information is sent to the display LED 21, and the display LED 21 controls each of LED0 to LED3 by turning on and off each LED according to the LED illumination information. Regarding other error codes, “11” and “12” are the error contents relating to paper jamming (JAM), “20” to “22” are the error content relating to running out of toner, and “35” and “36” are overflow error and specification violation error with respect to a memory. Each of the error codes has unique LED illumination pattern.

FIG. 7(a) shows the status of the LED0 to the LED3 before obtaining the error, and the display unit comprised of the four LEDs are attached to a portion of the body of the printing apparatus to show the error information to the user. In this example, the obtained LED illumination information is “LED0:ON, LED1:OFF, LED2:OFF, LED3:OFF”, and accordingly, the LEDs illuminate as shown in FIG. 7(b) (S6). This simple display unit comprised of the four LEDs can be equipped on the printing apparatus adequately cheaper than a display unit showing a message about the error on a liquid crystal display unit.

The error code controller 20 notifies a printer error to the infrared controller 15 via the communication controller 13 upon receiving the error printer information (S7). Upon being notified of the printer error, the infrared controller 15 activates the infrared transmitter 18, obtains the printer error information from the error code controller 20, and keeps on transmitting error information, i.e., data regarding “JAM has occurred (at the front panel). Please open the front panel and remove the paper.” from the infrared transmitter 18 (S8).

Where the user pushes the infrared communication stop button 22, the infrared communication stop button 22 notifies infrared communication stop instruction to the infrared controller 18 via the communication controller 13. Upon receiving the infrared communication stop instruction, the infrared controller 18 stops transmission of the error information (In the case of YES, S9). FIG. 7(c) shows the display unit when the user U1 pushes the infrared communication stop button 22.

FIG. 8 is a flowchart showing steps in which the portable telephone 3 receives the error information from the printer 2 and displays the received error information on a display unit. First, the communication controller 28 of the portable telephone 3 controls the infrared communication unit 29 to begin reception (S11). At this moment, a prescribed procedure for wireless connection is performed. The infrared communication unit 29 of the portable telephone 3 receives the error information transmitted from the printer 2 (S12).

The communication controller 28 stores the received error information in the memory unit 24 (S13). The controller 23 reads the error information stored in the memory unit 24, and transfers the error information to the LCD display unit 25. The LCD display unit 25 displays an error message based on the received error information (S14). For example, the printer 2 keeps on transmitting the error information including the error message as shown in FIG. 9, and the error message is in a prescribed language understandable to the user. The amount of the error message is set to be constant regardless of the error information. When receiving the error message, the portable telephone 3 terminates reception upon receiving a previously configured size of the data. A time difference exists between the start of transmission of the error message from the printer 2 and the start of reception by the portable telephone 3, and thus, the error message is usually received from the middle of the error message as shown in FIG. 9. In such case, only a received portion of the message is displayed on the display unit 25 as shown in FIG. 10 (a) and FIG. 10(b).

The error message in FIG. 9 has the format in which the error message starts with “*** start message ***” and ends with “*** end message ***”. Accordingly, the portable telephone 3 may have a message sorting means or application, for example, a program to sort the received data by searching for “*** start message ***” as the start of the message and searching for “*** end message ***” as the end of the message, so that the error messages can be converted to a format easier to read and understand as shown in FIG. 10(c).

As hereinabove described, in the printing system according to the first embodiment of the present invention, the printer 2 and the portable telephone 3 authenticate each other via infrared communication, the printer 2 transmits the error information serving as the printing apparatus information to the portable telephone 3, and the portable telephone 3 displays the received error information on the LCD display unit 25 serving as the display unit, so that the printing system has an advantageous effect that the printer 2 and the portable telephone 3 directly communicate with each other and the portable telephone 3 can display the error information of the printer 2 on the display unit. Thus, the printer 2 itself does not need to have the liquid crystal panel and the like showing the apparatus status and the error message in detail, and the present invention achieves to decrease the manufacturing cost of the printer 2.

### Second Embodiment

The schematic diagram of the printing system according to the second embodiment of the present invention is the same as FIG. 1 describing the first embodiment, and thus, the description thereabout is omitted. The connection diagram between the personal computer 1 and peripheral devices according to the second embodiment of the present invention is also the same as FIG. 2 describing the first embodiment, and thus, the description thereabout is omitted. The control block diagram of the portable telephone 3 according to the second embodiment of the present invention is also the same as FIG. 4 describing the first embodiment, and thus, the description thereabout is omitted.

FIG. 11 is a control block diagram of a printer 32 according to the second embodiment of the present invention. FIG. 11 shows the printer 32 having an infrared receiver 19 in an infrared controller 15a in addition to the elements of the printer 2 of the first embodiment shown in FIG. 3. The infrared receiver 19 is an interface receiving infrared transmitted from an apparatus according to the IrDA standards.

Operation of the second embodiment is hereinafter described with reference to FIGS. 12, 13, and 21. FIG. 12 is a flowchart showing steps in which the personal computer 1 transmits the print job to the printer, the printer prints the print job and detects and judges the printer error information at the print unit, and the printer finishes processing after the detection and the judgment. It should be noted that operation of steps S21 to S27 in FIG. 12 is the same as steps S1 to S7 in FIG. 5 used in the first embodiment.

That is, the user uses the personal computer 1 to transmit the image data. The receiver 14 in the printer 32 begins to receive the image data via the local area network 4 (S21). The print job administration unit 11 in the printer 32 receives the received image data via the communication controller 13, and generates the print job corresponding to the received image data (S22). The print job administration unit 11 transmits the generated print job to the print unit 9, and the print unit 9 prints the image corresponding to the print job (S23).

Where an error occurs in the print unit 9 during printing, the controller, not shown, in the print unit notifies the printer information controller 12 of the printer error information. In the event of the printer error information, the printer error information detector 16 obtains the prescribed error code, for example, the error code “10” (S24). Where the printer error information detector 16 does not detect the printer error information, this processing terminates normally. Where the printer error information detector 16 detects the error, step S25 is performed, and the error content corresponding to the error code is read out of the error code list, and the LED illumination information is obtained.

Then, the LEDs arranged on the body of the printing apparatus are illuminated according to the obtained LED illumination information (S26). The LEDs are illuminated in a similar manner as shown in, for example, FIG. 7(a) and FIG. 7(b). The error code controller 20 notifies the printer error to the infrared controller 15a via the communication controller 13 upon obtaining error information (S27).

Upon receiving the printer error, the infrared controller 15a activates the infrared transmitter 18, obtains the error information from the error code controller 20, and keeps on transmitting the error information, namely, data about “JAM has occurred (at the front panel). Please open the front panel and remove the paper.” from the infrared transmitter 18 (S28).

The infrared receiver 19 detects a signal from a communicating apparatus according to the IrDA standards. That is, the infrared receiver 19 should detect the signal if the portable telephone 3, the communicating apparatus, starts transmitting a communication start signal within a communication range (S29). Where the printer 32 and the portable telephone 3 recognize each other within the communication range, the infrared transmitter 18 of the printer 32 notifies a data transmission start signal (S30). The infrared receiver 19 goes into a stand-by status waiting for a data reception ready signal transmitted from the portable telephone 3 (S31). Where the printer 32 and the portable telephone 3 detect each other via infrared communication and become ready to perform data communication, the infrared controller 15a of the printer 32 makes the infrared transmitter 18 transmit the error information (S32). The infrared receiver 19 waits for an error information reception completion notification, and terminates reception upon detecting the error information reception completion (S33).

FIG. 13 is a flowchart showing steps in which the portable telephone 3 receives the printer error information from the printer 32 and displays the received error information on the display unit. Upon IrDA communication starts, the infrared communication unit 29 of the portable telephone 3 goes into a stand-by state waiting for the communication start signal within a range capable of IrDA communication (S41). When the infrared communication unit 29 detects the communication start signal transmitted from the printer 32, the infrared communication unit 29 transmits the communication start signal to the printer 32 within the range capable of IrDA communication (S42). The infrared communication unit 29 waits for the data transmission start signal transmitted from the printer 32, and when the infrared communication unit 29 receives the data transmission start signal (S43), the infrared communication unit 29 transmits the data reception ready signal (S44). Subsequently, the infrared communication unit 29 receives error information transmitted from the infrared controller 15a of the printer 32 (S45).

A signal indicating the end of the data is attached to the end of error information transmitted from the infrared controller 15a of the printer 32, and the infrared communication unit 29 waits for receiving the signal indicating the end of the data (S46). Where the signal indicating the end of the data is received, the infrared communication unit 29 notifies the infrared receiver 19 of the printer 32 of the error information reception completion (S47). Steps S48 and S49 are the same operation as steps S13 and S14 in FIG. 8 for the first embodiment, and the communication controller 28 stores the received error information in the memory unit 24 (S48). The controller 23 reads out the error information stored in the memory unit 24, and transfers the read error information to the LCD display unit 25. The LCD display unit 25 displays the error message based on the received error information (S49).

The portable telephone 3 operating as described above can display the error message on the LCD display unit 25 of the portable telephone 3 as shown in FIG. 10(c) described previously even where the portable telephone 3 does not have a function to sort the order of data. That is, the transmission of the error information is finished when the portable telephone 3 receives the signal indicating the end of the data and the infrared communication unit 29 notifies the error information reception completion notification to the infrared receiver 19 of the printer 32, and thus, it is not necessary for the portable telephone 3 to sort the order of the data of the error message.

As hereinabove described, in the printing apparatus according to the second embodiment, the printer and the portable telephone recognizes each other via infrared communication according to IrDA standers, the printer transmits the error information to the portable telephone, and the portable telephone displays the received error information on the display unit. Accordingly, the error message on the display unit of the portable telephone is easy to read and understand, and it is not necessary to sort the order of the error information that the portable telephone receives, and thus, the printing apparatus according to the second embodiment is advantageous in improving the processing efficiently.

### Third Embodiment

The overall configuration diagram of the printing system according to the third embodiment of the present invention is the same as FIG. 1 showing the first embodiment, and thus, the description thereabout is omitted. The block diagram of the personal computer 1 according to the third embodiment of the present invention is also the same as FIG. 2 describing the first embodiment, and thus, the description thereabout is omitted. The block diagram of the portable telephone 3 according to the third embodiment of the present invention is also the same as FIG. 4 describing the first embodiment, and thus, the description thereabout is omitted.

FIG. 14 is the block diagram of the printer 42 according to the third embodiment of the present invention. The printer 42 shown in FIG. 14 has an error detection LED 43 and an infrared communication button controller 45 in addition to the elements of the printer 2 shown in the block diagram of FIG. 11 describing the second embodiment. Where the error code controller 20 receives the printer error, the error code controller 20 controls the error detection LED 43 to illuminate the error detection LED 43. The infrared communication button controller 45 has an infrared communication start button 44 in addition to the infrared communication stop button 22 that the printing apparatus of the previous embodiments has. Where the infrared communication stop button 22 is pushed, the infrared communication stop button 22 controls the communication controller 13 to stop the infrared communication. Where the infrared communication start button 44 is pushed, the infrared communication start button 44 controls the communication controller 13 to start the infrared communication. The infrared communication stop (IrDA stop) button 22 and the infrared communication start (IrDA start) button 44 are arranged on the outside of the body of the printer 42 at a position that the user can manipulate, and the user operates the infrared communication stop button 22 and the infrared communication start button 44 to control start and stop of the infrared communication.

Operation of the printing apparatus according to the third embodiment structured as described-above is hereinafter described with reference to FIG. 15 and FIG. 16(a) to FIG. 16(c). FIG. 15 is a flowchart showing steps in which the personal computer 1 transmits the print job to the printer 42, the printer 42 prints the image based on the print job, the printer 42 detects and judges the printer error information at the print unit, and the printer 42 finishes processing after the detection and the judgment.

Operation shown in steps S51 to S57 in FIG. 15 is the same as steps S21 to S27 in FIG. 12 of the second embodiment. Steps S51 to S57 are briefly described below. First, the user uses the personal computer 1 to transmit the image data. The receiver 14 in the printer 42 receives the image data via the local area network 4 (S51). The print job administration unit 11 in the printer 42 receives the received image data via the communication controller 13, and generates the print job corresponding to the received image data (S52). The print job administration unit 11 transmits the generated print job to the print unit 9, and the print unit 9 prints the image corresponding to the print job (S53).

Where an error occurs in the print unit 9 during printing, the printer information controller 12 is notified of the printer error information. In the event of the printer error information, the printer error information detector 16 obtains the prescribed error code, for example, the error code “10” (S54). Where the printer error information is not detected, this processing terminates normally. Where an error is detected, step S55 is performed, and the error content corresponding to the error code is read out of the error code list, and the LED illumination information is obtained.

Then, the LEDs arranged on the body of the printing apparatus are illuminated according to the obtained LED illumination information (S56). The error code controller 20 notifies the printer error to the infrared controller 15a via the communication controller 13 upon obtaining the error information (S57). As shown in FIG. 16(a), the LED display unit of the present invention is comprised of the infrared communication start button 44, the infrared communication stop button 22, the display LED 21, namely, LED0 to LED3, and the error detection LED 43, namely, ERR_LED. FIG. 16(a) shows the display LED where no error is detected. FIG. 16(b) shows how the display LED illuminates where the error code “10” is detected. In this status, the LED0 and ERR_LED illuminate.

Then, FIG. 16(c) shows the display LED where the infrared communication start button 44 is pushed. Where the communication start button 44 is pushed, the infrared communication button controller 45 requests the communication controller 13 to start infrared communication. Upon receiving the infrared communication start request, the communication controller controls the infrared controller 15a to start communication.

Steps S59 to S64 in FIG. 15 show operation where the infrared communication start button 44 is pushed. Operation in steps S59 to S64 in FIG. 15 is the same as steps S28 to S33 in FIG. 12 describing the second embodiment. Steps S59 to S64 are briefly described below. The infrared controller 15a makes the infrared transmitter 18 start to transmit the error information via the signal according to IrDA standards (S59). The infrared receiver 19 detects a signal from the communicating apparatus according to the IrDA standards, namely, the portable telephone 3 (S60). Where the printer 42 and the portable telephone 3 recognize each other within the communication range, the infrared transmitter 18 of the printer 42 notifies the data transmission start signal (S61). The infrared receiver 19 goes into a stand-by status waiting for the data reception ready signal transmitted from the portable telephone 3 (S62). Where the printer 42 and the portable telephone 3 detect each other via infrared communication and become ready to perform data communication, the infrared controller 15a of the printer 42 makes the infrared transmitter 18 transmit the error information (S63). The infrared receiver 19 waits for the error information reception completion notification, and terminates reception upon detecting the error information reception completion (S64).

As hereinabove described, the printing apparatus according to the third embodiment is equally advantageous as that of the second embodiment, and the printing apparatus according to the third embodiment illuminates the error detection LED 43 to notify the user that the printer error information is detected, and starts IrDA communication after the user pushes the infrared communication start button 44, so that the printing apparatus does not transmit the printer error information to a wrong user within IrDA communication range. Further, in the third embodiment, IrDA communication is started when the user pushes the infrared communication start button 44, and accordingly, the printing apparatus is not kept in the stand-by status waiting for communication. Thus, the third embodiment is advantageous in improving the processing efficiency and power-saving rate.

### Fourth Embodiment

The overall structure of the printing system according to the fourth embodiment of the present invention is the same as FIG. 1 describing the first embodiment, and thus, the description thereabout is omitted. The block diagram of the personal computer 1 according to the fourth embodiment of the present invention is also the same as FIG. 2 describing the first embodiment, and thus, the description thereabout is omitted. The block diagram of the portable telephone 3 according to the fourth embodiment of the present invention is also the same as FIG. 4 describing the first embodiment, and thus, the description thereabout is omitted.

FIG. 17 is the block diagram of the printer 52 according to the fourth embodiment of the present invention. In addition to the elements of the printer according to the third embodiment, the printer 52 shown in FIG. 17 has a pushing duration measuring unit 54 inside an infrared communication button controller 53, a printer error record administration unit 56 inside a printer information controller 55, a transmission information selector 57 activated by a signal from the printer information controller 55, and a transmission information notification LED 58 activated by a signal from the transmission information selector 57.

The pushing duration measuring unit 54 measures a duration for which the infrared communication stop button 22 or the infrared communication start button 44 inside the infrared communication button controller 53 is pressed down, and memorizes the measured duration. The transmission information selector 57 has a function to select what data is to be transmitted from the infrared transmitter 18 of the infrared controller 15a, and transmits to the communication controller 13 the result of selection, namely, output selector information. The printer error record administration unit 56 makes and renews a log or table about error records every time the printer error information detector 16 detects the error, and stores and reads the error record log in the memory unit 10. The transmission information notification LED 58 controls illumination of the LEDs according to the output selector information after the transmission information selector 57 transmits the output selector information.

Operation of the present embodiment is hereinafter described with reference to FIG. 18 and FIG. 19. FIG. 19 is a flowchart showing steps in which the printer 52 transmits the print job to the printer 52, the printer 52 prints the image according to the print job, the print unit 9 detects and judges the printer error information, and the printer finishes processing after the detection and the judgement. Operation of steps S71 to S78 in FIG. 18 and FIG. 19 is the same as steps S51 to S58 in FIG. 15 describing the third embodiment. Steps S71 to S78 are briefly described below. First, the user uses the personal computer 1 to transmit the image data. The receiver 14 in the printer 52 receives the image data via the local area network 4 (S71). The print job administration unit 11 in the printer 52 receives the received image data via the communication controller 13, and generates the print job corresponding to the received image data (S72). The print job administration unit 11 transmits the generated print job to the print unit 9, and the print unit 9 prints the image corresponding to the print job (S 73).

Where an error occurs in the print unit 9 during printing, the printer information controller 55 is notified of the printer error information. In the event of the printer error information, the printer error information detector 16 obtains the prescribed error code, for example, the error code “10” (S74). Where the printer error information is not detected, this processing terminates normally. Where an error is detected, step S75 is performed, and the error content corresponding to the error code is read out of the error code list, and the LED illumination information is obtained.

Then, the LEDs arranged on the body of the printing apparatus are illuminated according to the obtained LED illumination information (S76). The error code controller 20 notifies the printer error to the infrared controller 15a via the communication controller 13 upon obtaining the error information (S77). Then, where the infrared communication button 44 is detected to be pushed at step S78, the pushing duration measuring unit 54 inside the infrared communication button controller 53 starts to count a duration for which the button is pressed down (S79). Then, the pushing duration measuring unit 54 waits until the infrared communication button 44 is no longer detected to be pushed (S80). When the infrared communication button 44 is no longer detected to be pushed, the pushing duration measuring unit 54 inside the infrared communication button controller 53 stops counting the duration (S81).

When the pushing duration measuring unit 54 stops counting, a value in the pushing duration measuring unit 54 is determined, and the value is notified to the transmission information selector 57 via the communication controller 13. Where the value in the pushing duration measuring unit 54 is, for example, one second or less, the transmission information selector 57 reads out the error information from the error code controller 20 (S82, S83). At this moment, the LED display unit becomes as shown in FIG. 20(a). It should be noted that STS_LED is the transmission information notification LED 58, and where the value in the pushing duration measuring unit 54 is, for example, one second or less, STS_LED does not illuminate.

Where the value in the pushing duration measuring unit 54 is more than one second, the transmission information notification LED 58 illuminates (S84). Where the value in the pushing duration measuring unit 54 is more than one second but not more than 3 seconds, the transmission information selector 57 reads the printer status information from the printer status information detector 17 inside the printer information controller 55 (S84 to S86). In such case, the LED display unit becomes as shown in FIG. 20(b), and where the value in the pushing duration measuring unit 54 is more than one second but not more than 3 seconds, the transmission information notification LED 58 continues to illuminate to show that the printer status information has been read out because the STS_LED is the transmission information notification LED 58 (S87).

Where the value in the pushing duration measuring unit 54 is more than 3 seconds, the transmission information selector 57 reads error record information of the printer from the printer error record administration unit 56 inside the printer information controller 55 (S87, S88). In such case, the printer display unit becomes as shown in FIG. 20(c), and the transmission information notification LED 58, i.e., STS_LED, illuminates more brightly than it illuminates where the printer status information is read out. Such control is easily realized by increasing the electrical current driving the LED. The LED may also be made blinking, or the wave length of illumination may be changed by varying the electrical current and varying the combination of illuminating elements. Further, different combination of beep sounds may be employed depending on the selected detection target. Instead of the pushing duration measuring unit 54, the selection can be made by changing the number of pushing of the button, namely, single click, double click, and the like.

Operation of steps S87 to S92 in FIG. 19 is the same as the steps S59 to S64 in FIG. 15 showing the third embodiment. Steps S87 to S92 are briefly described below. The infrared controller 15a makes the infrared transmitter 18 start to transmit the error information via the signal according to IrDA standards (S87). The infrared receiver 19 detects a signal from the communicating apparatus according to the IrDA standards, namely, the portable telephone 3 (S88). Where the printer 52 and the portable telephone 3 recognize each other within the communication range, the infrared transmitter 18 of the printer 52 notifies the data transmission start signal (S89). The infrared receiver 19 goes into the stand-by status waiting for the data reception ready signal transmitted from the portable telephone 3 (S90). Where the printer 52 and the portable telephone 3 detect each other via infrared communication and become ready to perform data communication, the infrared controller 15a of the printer 52 makes the infrared transmitter 18 transmit the error information (S91). The infrared receiver 19 waits for the error information reception completion notification, and terminates reception upon detecting the error information reception completion (S92).

As hereinabove described, the printing apparatus according to the fourth embodiment is equally advantageous as that of the third embodiment, and the printing apparatus according to the fourth embodiment selects only necessary information from among the error information, the printer status information, the error record information, and the like to reduce the amount of data during infrared communication, thus lightening the burden during communication. The reduced amount of data can also lighten the burden of processing on the portable telephone. The log or table about the error records generated by the printer error record administration unit 56 is stored in the memory unit 10, and accordingly, a maintenance engineer may read the log or table as necessary to determine the necessity of parts replacement.

Although the printer according to the present invention is described as an example in each of the above embodiments, a facsimile machine, a photo copier, an output apparatus of an image display apparatus, and the like made according to the present invention can also provide similar advantageous effects. Although the portable telephone is described as an example of the external processing apparatus, the present embodiment can also be applied to a notebook personal computer, a portable information terminal, a portable game apparatus, and the like as the external processing apparatus. Where multiple portable telephones exist in an office and the like, a priority order may be assigned to each portable telephone receiving notification, and the memory unit 10 may store information about the priority order as a table format therein to easily realize priority order function. In each of the above embodiments, each unit shown in the block diagram may be hardware, or may be structured with component parts realizing a required function using a prescribed software.

IrDA communication, infrared communication according to IrDA standards, is described as an example of short-range wireless communication method in each of the above embodiments. However, wireless LAN (for example, IEEE 802.11b), ultra-wideband (UWB), wireless spread spectrum communication (for example, Bluetooth, a trademark of BLUETOOTH SIG, INC. CORPORATION), and the like may also be employed as the short-range wireless communication method used by the printing apparatus.

In the description of the above embodiments, messages are displayed on the liquid crystal panel display and the like of the portable telephone. However, a special application program for the printer may be installed on the portable telephone to add beep sounds, voice messages, and display with symbols and images. Alternatively, the messages may be sent to the portable telephone via e-mail.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention should not be limited by the specification, but be defined by the claims set forth below.

What is claimed is:

1. A printing apparatus performing printing upon receiving print information generated by a print information generation apparatus, the printing apparatus comprising:
a short-range data communication unit communicating with an external processing apparatus,
wherein the printing apparatus transmits printing apparatus information showing a status of the printing apparatus to the external processing apparatus via the short-range data communication unit.

2. The printing apparatus according to claim 1, wherein the short-range data communication unit performs wireless communication.

3. The printing apparatus according to claim 2, wherein the wireless communication is performed by one or more methods selected from the group consisting of wireless infrared communication, ultra-wideband communication, and wireless spread spectrum communication.

4. The printing apparatus according to claim 1, wherein the printing apparatus has a display unit displaying the printing apparatus information by illuminating multiple illumination elements according to an illumination pattern.

5. The printing apparatus according to claim 1, wherein the external processing apparatus is a portable telephone.

6. The printing apparatus according to claim 1, wherein the short-range data communication is controlled to start and stop according to an error detection of the printing apparatus.

7. The printing apparatus according to claim 1, wherein the printing apparatus or the external processing apparatus has an operation unit allowing a user to enter an input, and wherein the short-range data communication is controlled to start and stop according to the input entered by the user to the operation unit.

8. The printing apparatus according to claim 7, wherein the printing apparatus information includes a plurality of data, and wherein the operation panel allows the user to select one or more of the plurality of data in the printing apparatus information, and wherein the printing apparatus transmits only the selected one or more of the plurality of data in the printing apparatus information.

9. A printing apparatus performing printing upon receiving print information generated by a print information generation apparatus, the printing apparatus comprising:
a short-range data communication unit communicating with an external processing apparatus having a display unit,
wherein the printing apparatus transmits printing apparatus information showing a status of the printing apparatus to the external processing apparatus via the short-range data communication unit, so that the printing apparatus information is displayed on the display unit of the external processing apparatus.

10. The printing apparatus according to claim 9, wherein the printing apparatus or the external processing apparatus has an operation unit allowing a user to enter an input, and wherein the short-range data communication is controlled to start and stop according to the input entered by the user to the operation unit.
